(19) United States
(12) Patent Application Publication
(10) Pub. No.: US 2009/0184440 A1
(43) Pub. Date: Jul. 23, 2009

(54) MOLDING EQUIPMENT AND METHOD TO MANUFACTURE STACKABLE INTER-ENGAGING BRICKS, BLOCKS, STONES AND THE LIKE WITH A SMOOTH OR EMBOSSED FACE

(76) Inventors: Dominic Chaussee, Montréal (CA); Luis Trelles Turgeon, Montreal (CA); Simon Gauthier, Rosemere (CA)

Correspondence Address: BROUILLETTE & PARTNERS, METCALFE TOWER, 1550 METCALFE STREET, SUITE 800, MONTREAL, QC, H3A-1X6, CA

(21) Appl. No.: 11/813,374

(22) PCT Filed: Jan. 9, 2006
(86) PCT No.: PCT/CA2006/000014

§ 371 Date: Jun. 12, 2008

(30) Foreign Application Priority Data
Nov. 1, 2005 (CA) 2,492,250

(51) Int. Cl. B28B 1/14; B28B 1/00

(52) U.S. Cl. 264/299; 249/99

(57) ABSTRACT

A molding equipment and method to mold stackable inter-engaging bricks, blocks, stones and the like and bricks, blocks, stones and the like produced therewith are disclosed. The molding equipment comprises a main structure which contains individual cavities. Each cavity preferably has a middle structure to which a brick separating element can be attached. Without the brick separating element, each cavity can form two attached splittable bricks whereas with the brick separating element attached, each cavity can hold two individual smooth or embossed face bricks. The size and shape of the stackable inter-engaging bricks is such that once out of the mold but still in an uncured form, the said brick can stand on its side without falling down, being damaged, buckling or being otherwise deformed during the manufacturing process.

### TITLE OF INVENTION

A molding equipment and method to manufacture stackable inter-engaging bricks, blocks, stones and the like with a smooth or embossed face.

### FIELD OF INVENTION

The present invention relates to the field of stackable inter-engaging bricks, blocks, stones and the like for building mortarless walls. This invention relates more precisely to the process of manufacturing individual smooth or embossed face or attached splittable inter-engaging bricks, blocks, stones and the like. As used herein, the word “bricks” also refers to blocks, stones and the like.

### BACKGROUND OF THE INVENTION

Stackable inter-engaging bricks are used to build mortarless walls and this is known in the art. Wall building blocks which may be stacked and interlocked without being held together by a binding agent such as mortar are known. One such block has a top face which comprise a tongue element and a bottom face which comprise a mortise element. Both elements are configured in such a way that when two blocks are stacked, the bottom face of a block engages with the top face of a like block disposed below while the top face of the block engages with the bottom face of an above-disposed block. An example of such a block is shown in U.S. Pat. No. 6,108,995 (Bouchard et al.).

In the process of manufacturing stackable inter-engaging bricks, multiple attached splittable bricks made of brick material such as concrete are first cast in a metal mold. The molded attached brick units are then extracted from the said mold and conveyed through the manufacturing plant on steel or wood plates. The molded attached brick units are then cured in kilns in order to cure the said brick material. Once cured, each of the attached bricks are detached in the middle in two individual split face bricks by the mean of a known splitting equipment. In this embodiment, every molded attached brick unit can produce two split face bricks.

The reason for manufacturing two split face bricks from a single attached splittable brick unit is found in the fact that, prior the completion of the curing procedure, an uncured single brick would be too fragile to be conveyed in the manufacturing plant without being unacceptably damaged or deformed in the process. Conveying uncured individual prior art bricks would result in an increase of defective or rejected bricks.

Also, the process of cutting attached brick units into individual bricks causes the bricks to have split faces, which may not be always desired.

There is thus a need to find a mean by which stackable bricks could be molded, conveyed and cured individually without being damaged or deformed unacceptably and in such a way that the resulting brick faces could be smooth or embossed.

### OBJECT OF THE INVENTION

Accordingly, an object of the present invention is to provide a mean by which stackable bricks could be molded, conveyed and cured individually without being damaged or deformed in the process.

Another object of the present invention is to provide a method to manufacture two individual bricks in a single mold cavity without the need for a specialized cutting equipment.

Another object of the present invention is to provide molding equipment that can mold smooth face bricks while molding the said bricks.

Another object of the present invention is to provide molding equipment that can mold embossed face bricks while molding the said bricks.

Another object of the present invention is to provide molding equipment that can selectively mold individual smooth face bricks, embossed face bricks or attached brick units (which are to be cut further in the manufacturing process).

Another object of the present invention is to provide molding equipment to manufacture smooth or embossed face bricks which are cheap to manufacture.

One more object of the present invention is to provide molding equipment to manufacture smooth or embossed face bricks which are easy to manipulate.

Other and further objects and advantages of the present invention will be obvious upon an understanding of the illustrative embodiments about to be described or will be indicated in the appended claims, and various advantages not referred herein will occur to one skilled in the art upon employment of the invention in practice.

### SUMMARY OF THE INVENTION

To attain these and other objects which will become more apparent as the description proceeds. According to one aspect of the present invention, a method to manufacture both individual smooth or embossed face bricks or attached splittable bricks is provided. Each of the bricks has a tongue interlock element and a mortise interlock element configured in such a way that the bricks are in a mutual engagement when bricks, blocks or stones or the like are stacked one of top of the other.

Molding equipment in accordance with the present invention comprises a mold having at least one and preferably a plurality of cavities. Each cavity allows the formation of a pair of splittable bricks. A brick separating element may be installed in the middle of each cavity to allow the formation of two individual free standing bricks. The said brick separating element is secured in place by mean of a fastening device such as screws or bolts. Once the said brick separating element is installed, tire said attached splittable brick cavity is effectively separated in two individual mold cavities.

The said brick separating element has an upper part which contains openings. The said openings are provided to receive fasteners such as screws or bolts. The said fasteners are used to secure the brick separating element to the molding equipment main body.

The said brick separating element is made from a hard and resistant material such as steel or cast iron.

The said brick separating element can have a smooth surface or a surface with projection and/or cavities.

A method for manufacturing individual smooth or embossed face bricks using the said molding equipment and the said cavity separating element is also provided.

The method comprises: a) selecting the individual molds in which individual smooth face or embossed face bricks are to be molded, b) installing the said smooth face brick separating element in the selected molds, c) installing the said embossed face brick separating element in the selected molds, d) fastening the said smooth face brick separating element with fasteners, e) fastening the said embossed face brick separating element with fasteners, f) installing the said molding equipment in the molding machine.

The invention accordingly comprises the construction, combination of elements, and arrangement of parts which will be exemplified in the construction herein set forth, and the scope of the invention will be. indicated in the claims. Although the above summary describes more precisely the manufacturing of stackable inter-engaging bricks blocks, stones and the like to build mortarless wall on a structure, the present invention could also be used for example, to manufacture stackable inter-engaging bricks, blocks, stones and the like to build landscaping walls.

### BRIEF DESCRIPTION OF THE DRAWINGS

For a fuller understanding of the nature and object of the invention, reference should be had to the following detailed description taken in connection with the accompanying drawings in which:

FIG. 1. is an isometric view of prior art molding equipment used to manufacture splittable stackable inter-engaging bricks;

FIG. 2 is an isometric view of an individual stackable inter-engaging brick;

FIG. 3 is a top view of molding equipment to be used in manufacturing splittable stackable inter-engaging bricks in accordance with the present invention;

FIG. 4 is a top view of the molding equipment to be used in manufacturing individual smooth (or embossed) face stackable inter-engaging bricks in accordance with the invention;

FIG. 5 is a top view of two individual smooth (or embossed) face stackable inter-engaging bricks as produced in the molding equipment shown in FIG. 4;

FIG. 6 is an isometric of a single smooth face stackable brick in accordance with the invention;

FIG. 7 is a top view of splittable bricks as produced in the molding equipment shown in FIG. 3;

FIG. 8 is a side view of stacked bricks in accordance with the invention;

FIG. 9 is an isometric view of a single split face stackable brick in accordance with the invention;

FIG. 10 is a top view of smooth (or embossed) face bricks as produced in the molding equipment shown in FIG. 4;

FIG. 11 is an isometric view of a single embossed face stackable brick in accordance with the invention;

FIG. 12 is an isometric view of the brick separating element to be used in manufacturing smooth face stackable inter-engaging bricks;

FIG. 13 is an isometric view of the brick separating element to be used in manufacturing embossed face stackable inter-engaging bricks;

FIG. 14 is aside view of one brick separating plate to be used in manufacturing embossed face stackable inter-engaging bricks;

FIG. 15 is an isometric view of a possible pattern created by using several embossed face stackable inter-engaging bricks.

FIG. 16 is a top view of a prior art splittable stackable inter-engaging bricks as produced by a prior art molding equipment.

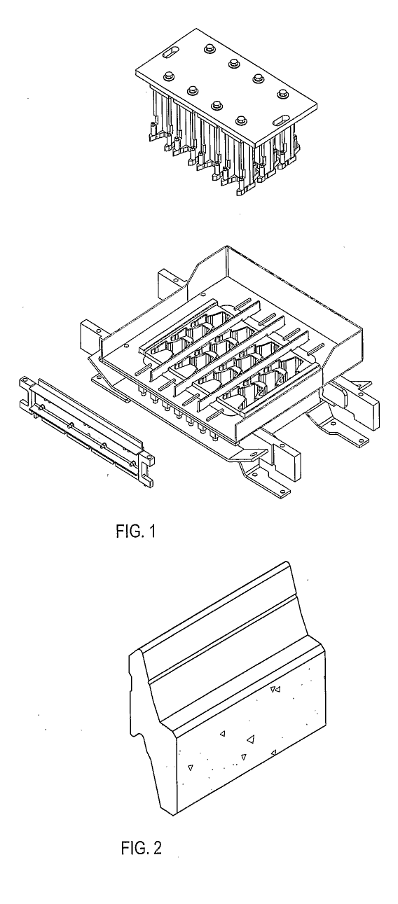

### DETAILED DESCRIPTION OF THE PREFERRED EMBODIMENTS

With reference to the annexed drawings, the preferred embodiments of the present invention will be herein described for indicative purposes and by no means as of limitation.

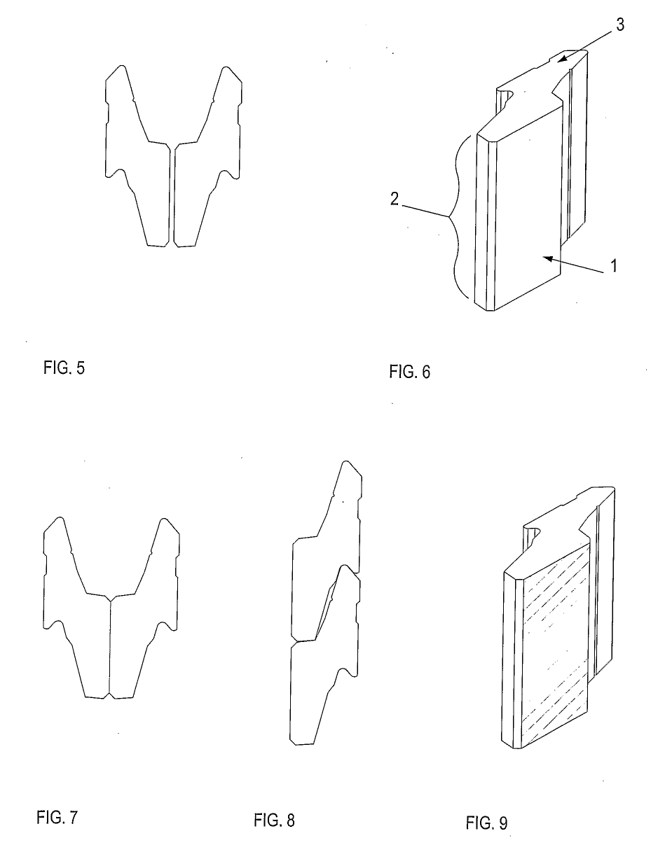

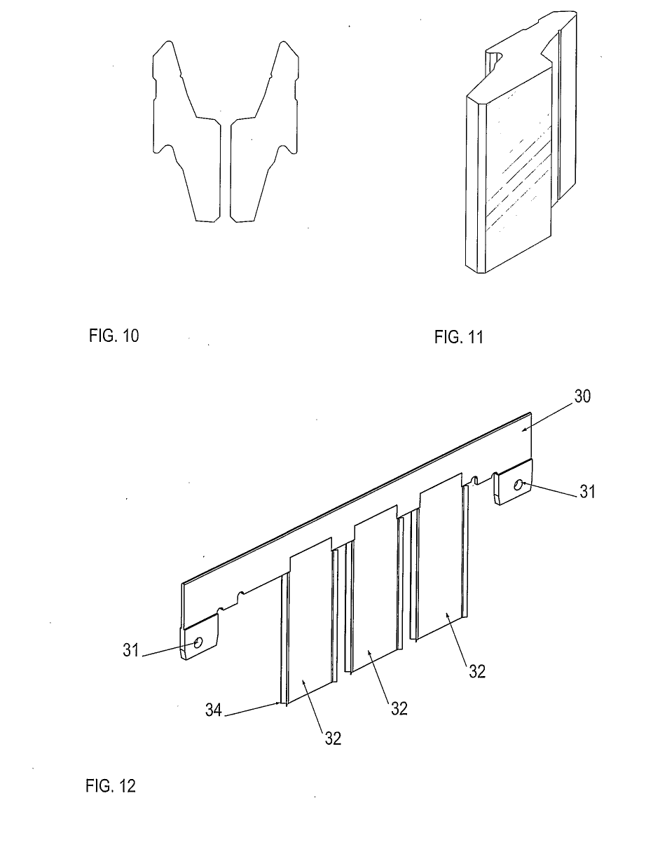

The drawings and the description attached to it are only intended to illustrate the idea of the invention. As to the details, the invention may vary within the scope of the claims. So, the size and shape of the individual stackable inter-engaging brick (1) (FIG. 6) may be chosen as desired, as long the said size and shape enable the said individual brick to stand on its side uncured as shown in FIG. 6 without falling over, being damaged, buckling or being otherwise deformed during the manufacturing process.

For example purpose only, referring to FIG. 6, a single individual stackable inter-engaging brick (1) with the side-section shape (3) shown will stand on its side uncured without falling over, being damaged, buckling or being otherwise deformed during the manufacturing process if the side-section area (3) to the brick length (2) ratio is 26.65:1. However, given other brick characteristics such as brick material, brick shape, brick side-section inertia momentum and brick length according to FIG. 6, the ratio would be different.

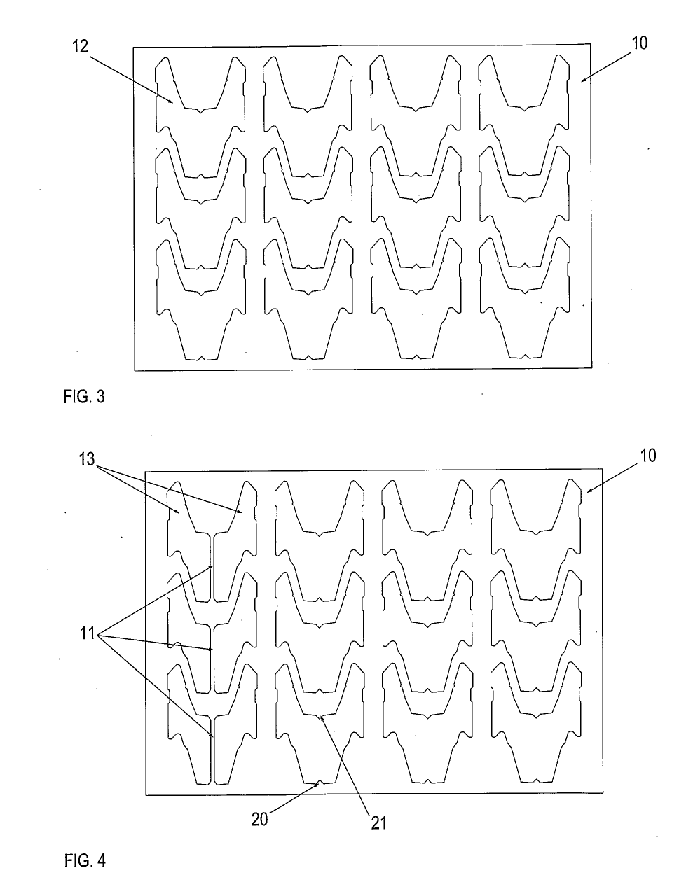

Referring to FIGS. 3 and 4, the molding equipment main body (10) is illustrated. Several cavities (12) are created in the molding equipment main body (10). The cavities (12) are used to cast the concrete or other appropriate material to produce bricks (not shown here).

FIG. 3 shows molding equipment for producing splittable brick units. However, hi FIG. 4, a brick separating element (11) has been attached to the mold (12) (see FIG. 3) at attachment points (20) and (21). The said brick separating element (11) attached at said attachment points (20) and (21) thus creates two separated cavities (13) to mold individual smooth or embossed face bricks.

FIG. 12 shows the brick separating element used to manufacture individual smooth face bricks. The upper part (30) of the said brick separating element has openings (31) at both ends of the said upper part to secure the said brick separating element to the molding equipment main body (10) (see FIGS. 3 and 4). The brick separating element may have several brick separating plates (32).

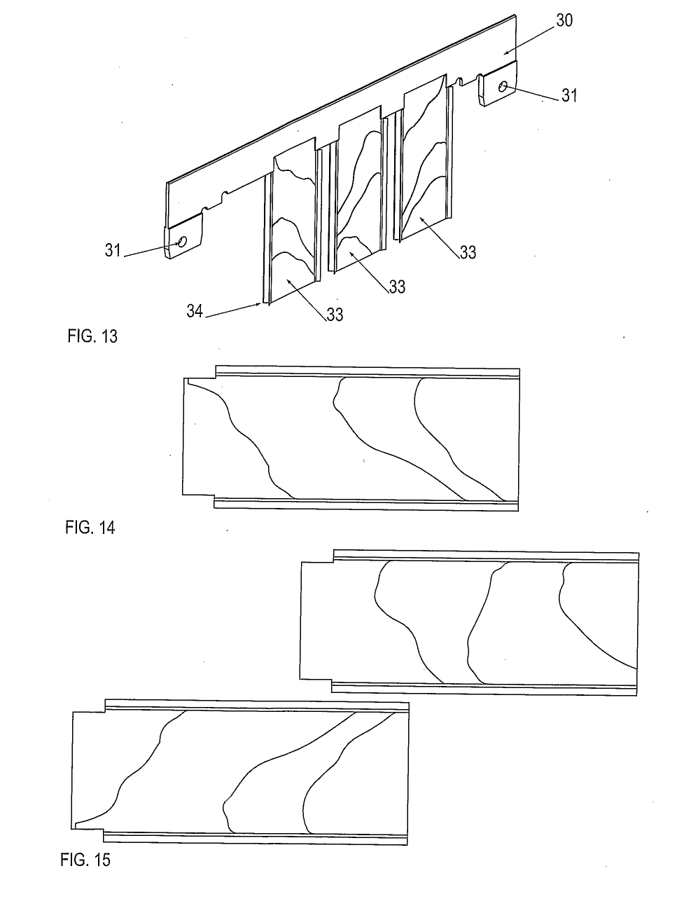

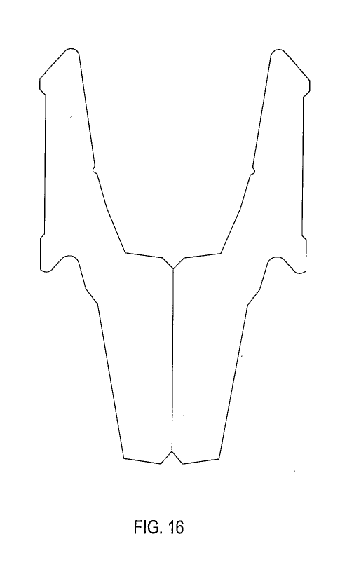

FIG. 13 shows the brick separating element used to manufacture individual embossed face bricks. The upper part (30) of the said brick separating element has openings (31) at both ends of the said upper part to secure the said brick separating element to the molding equipment main body (10) (see FIGS. 3 and 4). The brick separating element may have several brick separating plates (33).

Referring to FIGS. 12 and 13, smooth (32) and embossed (33) brick separating plates are illustrated. The said smooth (32) and embossed (33) brick separating plates have “V” shaped grooves (34) on each side to secure each brick separating plate (32)/(33) in the molding equipment main body (10) (see FIGS. 3 and 4).

Although the molding equipment and method for molding stackable inter-engaging bricks with smooth or embossed face has been described with a certain degree of particularity, it is to be understood that the disclosure has been made by way of example only and that the present invention is not limited to the feature embodiment(s) described and illustrated herein, but includes all variations and modifications within the scope and spirit of the invention as hereinafter claimed.

The embodiments of the invention in which an exclusive property or privilege is claimed are defined as follows:

1. A stackable inter-engaging brick, block, stone or the like made of concrete or other similar material with shape and size that enable the said brick to stand alone without being damaged, being deformed or buckling during its manufacturing.

2. A molding equipment which can mold multiple pairs of individual stackable inter-engaging bricks, each of said pairs of bricks being separated by a separating element placed between the exterior face of the said bricks.

3. The molding equipment according to claim 2, and including fastener opening to secure the bricks separating element to the mold.

4. The molding equipment according to claim 2, in which the separating element is attached to the mold by mean of screws, bolts or the like.

5. The brick separating element of the mold according to claim 2.

6. The bricks separating element according to claim 5, and including fastener opening to secure the separating element to the mold.

7. The bricks separating element according to claim 5, wherein the separating element is made of substantially hard and resistant material.

8. The brick separating plate according to claim 5, wherein said material is chosen from steel, cast iron.

9. The brick separating plate according to claim 5, wherein the material has a smooth surface.

10. The brick separating plate according to claim 5, wherein the material has an embossed surface.

11. A method for installing the brick separating element in the molding equipment. The said molding equipments being composed of multiple molds. The said method comprising of the following steps:
a. Selecting the molds in which to install the brick separating elements;
b. Sliding the brick separating element in the molds;
c. Fastening the brick separating element with a fastening device.

12. A method to manufacture individual separated smooth face bricks and attached split face bricks simultaneously, said method involving the use of the said molding equipment in which some bricks separating elements are installed in said molds. The said brick separating element having a smooth surface. The said method comprising of the following steps:
a. Selecting the molds in which to install tire brick separating elements;
b. Fastening the said smooth surface brick separating elements using said fastening device;
c. Installing the said molding equipment with said brick separation elements installed in said molds in the molding machine.

13. A method to manufacture individual separated embossed face bricks and attached split face bricks simultaneously, said method involving the use of tire said molding equipment in which some bricks separating elements are installed in said molds. The said brick separating element having an embossed surface. The said method comprising of the following steps:
a. Selecting the molds in which to install the brick separating elements;
b. Fastening the said embossed surface brick separating elements using said fastening device;
c. Installing the said molding equipment with said brick separation elements installed in said molds in the molding machine.

14. A method to manufacture individual separated smooth face bricks, embossed face bricks and attached split face bricks simultaneously, said method involving the use of the said molding equipment in which some bricks separating elements are installed in said molds. Some of the said brick separating element having a smooth surface, the remaining said brick separating element having an embossed surface. The said method comprising of the following steps:
a. Selecting the molds in which to install the said smooth surface brick separating elements;
b. Selecting the molds in which to install the said embossed surface brick separating elements;
c. Fastening the said smooth surface brick separating elements using said fastening device;
d. Fastening the said embossed surface brick separating elements using said fastening device;
e. Installing the said molding equipment with said brick separation elements installed in said molds in the molding machine.

15. A method to manufacture individual separated smooth face bricks and embossed face bricks simultaneously, said method involving the use of the said molding equipment in which bricks separating elements are installed in all said molds. Some of the said brick separating element having a smooth surface, the remaining said brick separating element having an embossed surface. The said method comprising of the following steps:
a. Selecting the molds in which to install the said smooth surface brick separating elements;
b. Selecting the molds in which to install the said embossed surface brick separating elements;
c. Fastening the said smooth surface brick separating elements using said fastening device;
d. Fastening the said embossed surface brick separating elements using said fastening device;
e. Installing the said molding equipment with said brick separation elements installed in said molds in the molding machine.

16. A method as described in claim 12 wherein in step a), all the molds are selected.

17. A method as described in claim 13 wherein in step a), all the molds are selected.

18. A method as described in claim 12 wherein in step a), none of the molds are selected.
